(19) United States
(12) Patent Application Publication
(10) Pub. No.: US 2022/0398570 A1
(43) Pub. Date: Dec. 15, 2022

(54) METHOD FOR PERFROMING CURRENCY EXCHANGE OPERATIONS AND A SYSTEM FOR IMPLEMENTATION THEREOF

(71) Applicants: Monashov Serhii Yevhenovych, Kyiv (UA); Yakibchuk Myroslav Illych, Kyiv (UA); Fred M. Mosely, Solon, OH (US)

(72) Inventors: Monashov Serhii Yevhenovych, Kyiv (UA); Yakibchuk Myroslav Illych, Kyiv (UA); Fred M. Mosely, Solon, OH (US)

(21) Appl. No.: 17/660,716

(22) Filed: Apr. 26, 2022

(30) Foreign Application Priority Data
Jun. 9, 2021 (UA) A 2021 03169

(51) Int. Cl. G06Q 20/38

(52) U.S. Cl. CPC G06Q 20/381

(57) ABSTRACT

A group of inventions relates to a method for performing currency exchange operations with a safe and quick transactionality, the method comprises steps of requesting an initiation of the currency exchange operation, confirming that the exchange operation is possible, providing the currency to be exchanged from depending on the selected money type, verifying depending on the selected money type, additional initiation of selecting the currency type, and performing the exchange, and a system that implements the method by combining a hardware and a software parts and enables an organization of a single access point to perform bidirectional operations with cash and/or cashless and/or digital money types, while providing their reliable verification.

### CROSS-REFERENCE TO RELATED APPLICATION

This application claims priority to Ukrainian Application No. a 2021 03169, filed Jun. 9, 2021, which is hereby incorporated by reference in its entirety.

### FIELD OF THE INVENTION

A group of inventions relates to a field of information technologies, particularly to a method for performing currency exchange operations and to a system for implementation thereof by means of self-service complexes.

### PRIOR ART

Currently, a system and a method for performing financial operations (money transfer, currency exchange, public services payment etc.), in which said operations are initiated by a client's visit to a bank institution, filing paper documents, and crediting a cash via a cashbox, are still widely known and used. All these procedures are long and inconvenient, they require personnel involvement, thereby limiting their usage exclusively by a working time of the bank institutions. Such systems are characterized by a low capacity due to a high number of manual operations, as well as a rather high probability of human factor-associated errors such as unintentional errors made by cashiers, malversation or thefts.

In a modern world, an increase of a pace of a population's life causes a need in simplification and acceleration of performing of many operations in various fields of human life, including in the field of performing bank operations, which is achieved due to a significant automation of processes and use of software and hardware self-service complexes (SHCs) and payment terminals (ATM).

The prior art discloses ATMs which are capable of performing various transactions, including currency issuance or receiving deposits for a user, issuing tickets, travel checks, vouchers or game materials. Other types of transaction machines allow to pay bills, to print account statements, to distribute postage expenses, and to receive or to provide other valuable papers. Other types of bank machines may be utilized by a services provider and include cash counters, receipt receivers, printers, and other devices. Usually, automated ATMs perform transactions by assigning certain expenses and credits to a certain user account, a terminal owner and/or to a provider of such values as cash, goods or services, which are effectively performed by means of the machine's operations.

So, a U.S. Pat. No. 6,443,359 (B1) dated Sep. 3, 2002 discloses a device and a system which allow to perform bank transactions on an automated basis. According to the invention, the automated ATM comprises an enclosure, a plurality of various transactions function devices which are arranged within the enclosure, the transaction function devices include at least one primary device that performs a first transaction and at least one fallback device that is capable of performing the first transaction, at least one tray that comprises a delivery area, a robotic item handling device for moving the items between the delivery area and the plurality of transaction function devices; at least one controller that is operatively connected to the delivery area and to the plurality of the transaction function devices, wherein the controller is operative to cause performing the first transaction by moving the items by means of the robotic device between the delivery area and the primary device to perform the first transaction, and, in case the primary device is unavailable, by moving the items with the robotic device between the delivery area and the fallback device. Therewith, the at least one transaction function device includes at least one processor and at least one memory unity having at least one software application arranged therein. The device and the system may perform transactions for several users simultaneously and they are easily configurable to add and to delete the transaction function devices, thereby changing types of the transactions, which may be performed, easier. In terms of a software solution architecture, at least one ATM computer comprises such software ATM objects as software components Java beans or Active X™ or COMM, each of them including many methods and functions, which are associated with capabilities of the devices for performing various transactions. Therewith, sets of rules and functions for the transaction function devices may be created and stored within a specialized data storage by means of a configuration software program that is operatively connected to the data storage. Therewith, the connection between each ATM object and the transaction function device is provided by the device interface level (XFS, ODS components, services, and device drivers).

A drawback of the invention lies in a complexity and a multi-level nature of the proposed architecture solution, thereby increasing a duration of the information processing and, thus, slows down the process of performing the transaction itself, as well as a bulkiness of the transaction function device when using several client interfaces, thereby making its usage within a limited space impossible.

With consideration of development of international tourism, international trade, and multi-nationality of the clients, which may participate in performing the financial operations, currency exchange operations are of a special attention among various bank transactions. Thus, a patent JP 5854527B2 as of Feb. 9, 2016 discloses a system and a method for a dynamic currency conversion, which propose a user (e.g., a payment card owner) an alternative currency for the payment. A transaction execution terminal system for a payment carrier system (e.g., payment card, mobile phone, personal digital assistant (PDA)) interacts with a host to perform the dynamic currency exchange. An effective utilization of a network capacity and a storage is provided due to combining ranges of the payment carriers numbers in order to create combined ranges of the payment carriers numbers, which are defined by the lowest payment carrier number from the first, low range of successive payment carriers numbers to the highest payment carrier number from another, high range of successive payment carriers numbers. According to the invention, the terminal transaction system comprises functionalities of the payment carriers and of a dynamic currency conversion (DCC) system, and it may be configured as a trading terminal or an ATM. The system may comprise one or several interfaces for receiving card payments and it maintains a communication with a bank computer system via a communication network (e.g., Internet, phone, and other network). A drawback of the invention lies in its limited functionality in view of performing currency operations only by means of such payment carriers as payment cards, mobile phones or PDAs, and in that it is impossible to perform the same operations with cash and digital money (cryptocurrency).

An invention application GB2566591 (A) dated Mar. 20, 2019 discloses a system and a method for dynamic converting a local currency into a cryptocurrency. According to the invention, the dynamic currency conversion system comprises a transaction terminal and a dynamic currency conversion host, the transaction terminal comprises an input and communication interface, the host comprises a communication interface, wherein a qualification request message is transmitted from the transaction terminal to the host, the request message includes a local currency identification and a conversion currency identification being a cryptocurrency, wherein the host determines the cryptocurrency conversion rate in response to a response to the message and transmits a response message to the transaction terminal. Therewith, the local currency is cash. Therewith, the request message comprises the local currency amount in the transaction terminal, while the response message comprises the converted cryptocurrency amount and the rate of conversion of the local currency into the cryptocurrency. As in the previous case, a drawback of the proposed solution lies in its limited functionality, since it implies only a unidirectional conversion of the currency into the cryptocurrency, as well as it does not imply cash money operations.

An invention application US2020219086A1 dated Jul. 9, 2020 discloses a payment terminal device for converting a terminal currency into a foreign currency when performing a contactless payment, wherein the terminal is associated with the terminal currency, as well as a method for implementation thereof. The payment terminal device comprises a reader for contactless payments carrier, the reader is configured to communicate with the contactless payments carrier, a communication module is configured to transmit messages to a remote location, and a controller. The controller is configured to receive, from the contactless payments reader, a payment data from the contactless payments carrier in order to complete the transaction, wherein the payment data comprises a cryptogram, while the transaction is associated with a transaction amount in the terminal currency, to store the received payment data with the cryptogram, to determine a currency for completion of the transaction, whether it will be the foreign currency or the terminal currency, wherein the foreign currency is a currency other than the terminal currency. Therewith, if it is determined that the transaction is to be completed in the foreign currency, the controller will generate a first-type authorization request message that includes a foreign currency indicator, the converted transaction amount that corresponds to the transaction amount that is converted into the foreign currency, a terminal currency indicator, the transaction amount, and the cryptogram. If it is determined that the transaction is to be completed in the terminal currency, the controller will generate a second-type authorization request message, wherein the second-type authorization request message comprises the terminal currency indicator, the transaction amount, and the cryptogram, and it transmits the generated authorization request message through the communication module to a remote location in order to complete the transaction. In this case, the cryptogram is the same cryptogram as generated by a contactless payment operator using the terminal currency and the transaction amount in the terminal currency. The contactless payments carrier may be a contactless credit card, a contactless debit card, an EMV contactless card, a contactless card with a chip, an EMV device, a mobile phone, a mobile application or a token payment system. A drawback of the disclosed invention lies in its narrow orientation to the currency exchange operations involving the contactless payments carriers only and in that it is impossible to use cash and a digital currency for the exchange.

### SUMMARY OF THE INVENTION

The claimed group of inventions is based on a task to combine advantages of the prior art, while resolving the above-mentioned drawbacks, that lies in developing a safe, due to avoiding the human factor, simple, 24/7 available method for performing currency exchange operations and a system for implementation thereof in a form of at least one peripheral device being universal, reliable, compact, understandable and convenient in use, the device is in a form of the SHC or ATM and may be mounted at any location and in conditions of a limited space, and which enable to achieve a technical effect that lies in providing a multi-transactional exchange of a wide spectrum of currencies, namely, cash, cashless, and digital (cryptocurrency) money to various currency types, without limitation to a bidirectional exchange only, enabling a payment according to the exchange types via cash, cashless, and mixed types of payments.

The posed task is resolved by the fact that the method for performing the currency exchange operation is performed in several steps, namely:

a step of requesting an initiation of the currency exchange operation using a client interface of a peripheral device such as a software and hardware self-service complex (SHC) or an ATM having an integrated XFS financial services extension module which consists of selecting a currency type to be exchanged from, and selecting a currency type to be exchanged to, selecting a money type from a range that includes cash, cashless or digital money, selecting a direction of the exchange operation from a range that includes purchasing, selling, converting, and entering a value of an initial amount of the operation with the selected currency and money types. According to the invention, it is possible to select up to 26 currency types and to exchange up to 6 currencies simultaneously;

a step of confirming that the exchange operation is possible by transmitting the initiation request from the control extension module to a server device having an architecture that includes an external operator interface and a software and hardware part that is integrated according to an ISO protocol with a processing center for payment cards operations and with APIs of payment services providers and automated systems of servicing banks, displaying the received data on the peripheral device interface with indication of an exchange rate of the set pair of currency types, limitation amounts of the exchange, and an amount of the currency type to be exchanged to depending on the amount of the currency type to be exchanged from;

a step of providing the currency to be exchanged from depending on the selected money type by depositing cash into a receipt device of a cash receipt and issuance module,

and/or a contact or contactless inputting of an information from a cashless money carrier such as international or local cards of VISA/MASTERCARD systems into a cashless operations module that is equipped with a PIN-on-Glass technology and devices with NFC,

and/or indicating a digital money identification data in a scanner code reader of the cashless operations module. The invention includes operations with the digital money BTC, BTH, LTC, DASH, ETH, RIPPLE, while use of another digital money is also possible without falling beyond the concept of the present invention;

a step of verifying depending on the selected money type, which includes checking the cash money after its introduction into a receiving portion of the peripheral device, by means of a complex infrared and/or ultraviolet and/or magnetic and/or OCR scanning performed by appropriate means integrated into the cash money receipt and issuance module of the peripheral device,

and/or verifying payment cards upon request to hosts of the card processing systems provider and the servicing bank by means of an online transaction to the processing center of the international payment system Visa International or MasterCard Worldwide in real time, while forming, by the processing center, a request to the system of the servicing bank and forming a response to the control module of the peripheral device,

and/or verifying a digital money account upon request to hosts of cryptocurrency providers by means of online verification according to a block chain technology;

wherein an intermediate step of additional initiation of selecting the currency type to be exchanged to from at least two money types is possible;

a step of exchanging by means of issuing a calculated amount of cash money of the selected currency from the peripheral device, a cash dispenser or recycling module and/or debiting from a cashless account and/or crediting to the cashless account and/or debiting from a cryptocurrency account and/or crediting to the cryptocurrency account. Therewith, a time for performing the transaction is up to 20 seconds.

In a second aspect, the invention provides a system that consists of at least one self-service complex comprising a software and hardware complex, which includes an operational control device that is a computer having an operating system that supports financial services, the computer is embedded into the self-service complex, equipped with an external client interface, and integrated with a XFS financial services extension module, which is capable of controlling devices of the self-service complex modules, which are a cash money storage module, a cash money receipt and issuance module, a cashless payment operations module, and a security module, wherein the operational control device of the self-service complex is coupled to a processing center for payment cards operations, payment services providers, cryptocurrencies providers, and automated systems of servicing banks, by means of a direct interaction with a remote central server that is equipped with an operator interface and is coupled by ISO protocols to the processing center for payment cards operations, to APIs of the payment services providers and of the cryptocurrency providers, and to APIs and/or by means of a file exchange with the automated systems of the servicing banks,

the operational control device of the complex is configured to initiate at least one currency exchange operation upon request through an external multilingual client interface with a formation of an authorization request to the central server, while the server provides in response, by calculating an exchange rate of at least one currency pair for at least one money type, limits of the amounts of currency exchange operation, and to confirm that the currency exchange operation is possible by exchanging data with at least one processing center and the operational control device of the complex,

and, upon confirmation of the necessity of conduction, performing the currency exchange operation by means of a cash settlement through the money receipt and issuance module of the self-service complex, the module combines paper and/or coin cash money receipt/issuance devices and physical complex verification devices which are infrared and/or ultraviolet and/or magnetic and/or OCR scanners,

and/or debiting from a cashless account and/or crediting to the cashless account, upon request to hosts of the cryptocurrency providers, through the module of cashless payment systems which implements ISO that combines a card reader, an EPP keyboard and an NFC module and/or debiting a digital money from a cryptocurrency account and/or crediting the digital money to the cryptocurrency account by online verification according to a block chain technology,

followed by formation and visualization of the report on a finalization of the currency exchange operation.

Therewith, according to one of separate embodiments of the system, the currency exchange operation with the cash involves issuing a change and/or returning the amount due to a means for temporary storing the cash after the complex verification thereof is performed.

Therefore, the combination of the hardware and software parts allows to achieve a high transactionality, while providing safety and speed for performing the currency exchange operations, and it enables to organize a single access point to perform bidirectional operations with three money types (cash/cashless/digital), while providing reliable verification thereof.

### BRIEF DESCRIPTION OF THE DRAWINGS

An exemplary embodiment of the method and the system, according to the group of inventions, is illustrated by the drawings, which depict the following:

FIG. 1 illustrates main elements of the system in the form of the SHC to implement the method for performing the currency exchange operation.

FIG. 2 illustrates a main implementation algorithm of the method for performing the currency exchange operation.

### IMPLEMENTATION OF THE GROUP OF INVENTIONS

The group of inventions is implemented in several embodiments according to the examples given below.

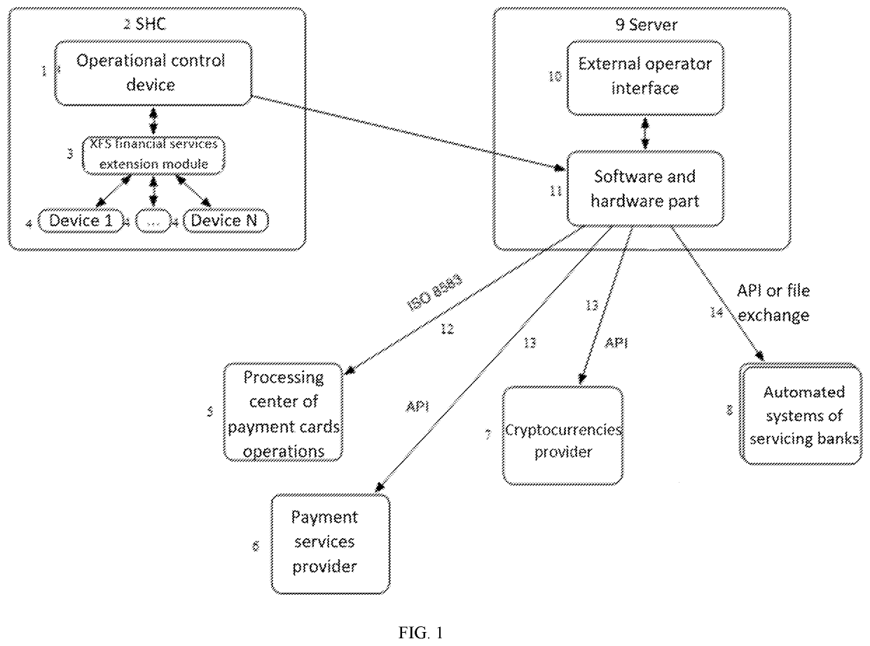

FIG. 1 illustrates elements of the system for implementing the method for performing the currency exchange operation, the elements include an operational control device 1 that is a computer having an operating system that supports financial services, the computer is embedded into the self-service complex SHC 2, equipped with an external client interface, and integrated with a XFS financial services extension module 3, which is suitable for controlling devices 4 of the self-service complex modules, which are a cash money storage module, a cash money receipt and issuance module, a cashless payment operations module, and a security module, wherein the operational control device 1 of the self-service complex 2 is coupled to a processing center 5 for payment cards operations, payment services providers 6, cryptocurrencies providers 7, and automated systems 8 of servicing banks, by means of a direct interaction with a remote central server 9 that is equipped with an operator external interface 10 and with an ISO-integrated software and hardware part 11, and it is coupled by ISO protocols 12 to the processing center 5 for payment cards operations, to APIs 13 of the payment services providers 6 and of the cryptocurrencies providers 7, and to APIs and/or by means of a file exchange 14 with the automated systems 8 of the servicing banks.

Therewith, the operational control device 1 of the SHC complex 2 is configured to initiate at least one currency exchange operation upon request through an external multilingual client interface with a formation of an authorization request to the central server 9, while the server 9 provides in response, by calculating an exchange rate of at least one currency pair for at least one money type, limits of the amounts of currency exchange operation, and confirmation that the currency exchange operation is possible by exchanging data with at least one processing center and the operational control device 1 of the complex 2. According to the invention, it is possible to select up to 26 currency types and to exchange up to 6 currencies simultaneously. Upon confirmation that the currency exchange operation is required to be performed, it will be performed in several ways depending on the money type: by means of a cash payment via the money receipt and issuance module of the self-service complex 2 that combines paper and/or coin cash money receipt/issuance devices and physical complex verification devices which are infrared and/or ultraviolet and/or magnetic and/or OCR scanners, and/or by debiting from a cashless account and/or crediting to the cashless account, upon request to hosts of the payment services providers 6 and of the servicing bank 8 by means of an online transaction to the processing center of the international payment system Visa International or MasterCard Worldwide in real time, while forming, by the processing center, a request to the system of the servicing bank 8 and forming a response to the operational control device 1 of the peripheral device 2 through the module of cashless payment systems which implements ISO that combines a card reader, an EPP keyboard and a NFC module and/or by debiting a digital money from a cryptocurrency account and/or crediting the digital money to the cryptocurrency account, according to the request to the hosts of the cryptocurrencies providers 7, by online verification according to a block chain technology, followed by formation and visualization of the report on a finalization of the currency exchange operation. The invention includes operations with the digital money BTC, BTH, LTC, DASH, ETH, RIPPLE, while use of another digital money is also possible without falling beyond the concept of the present invention.

Therewith, the currency exchange operation with the cash involves issuing a change and/or returning the amount due to a means for temporary storing the cash after the complex verification thereof is performed.

In order to perform the operation of debiting from the cashless account and/or crediting to the cashless account, the SHC 2 is equipped with a hardware and software solution to perform and maintain payment cards operations, namely, with an EPP keyboard to process PIN codes, a card reader that supports reading magnetic and chip cards, and a payment cards dispenser to perform a physical dispense payment cards.

In order to perform the payment cards operations, the self-service SHC 2 is registered in the processing center of the servicing bank 8. Any card operations are performed online, and only after the operation is successfully performed (a correct code+an authorization code), the SHC 2 performs other actions (cash issuance, currency exchange, cryptocurrency purchase etc.). All payment card operations are mandatory accompanied by the PIN code verification by interacting with the EPP keyboard. According to the group of inventions, cards of the following payment systems are to be serviced: Visa, MasterCard, UzCard, although use of other payment systems is also possible without falling beyond the concepts of the present group of inventions.

The remote central server 9 executes a number of functions to provide a normal operation of the system:

monitoring a state of the SHCs 2 that lies in receiving a real time information as to a current status of the performance of the complex, mounting addresses, durations of a continuous operation, a status of the devices 4 in case of their incorrect operation (e.g., the paper is over or there is no memory for a video), actual errors of the complex, current cash counters (the remainder of the cash in cassettes to be issued, a number of the cash received, division by denominations), thereby allowing not only to evaluate the current state, but also to track data exchange parameters (e.g., a history of receiving currency rates);

adjusting parameters of the SHCs 2 network such as a value of the currency rate for each currency pair, a value of maximum and minimum amounts of the operations, a value of commission for the operations on the complexes (to provide a correct calculation and informing the user), establishing regulations for the formation of report files from the currency exchange operations etc.;

collecting the SHCs 2 that lies in monitoring a financial state of the self-servicing complexes and planning collection dates;

maintaining the SHCs 2 that lies in receiving device logs and transaction/operation processing logs, as well as a remote control of the components/devices of the complex, including its reboot;

video recording of the SHCs 2;

providing safety that lies in adjusting a personnel (responsible persons) notification scheme for notifying regarding emergency situations at the complex, e.g., actuation of opening sensors or collection process. Notifying means transmitting SMS messages or emails or adjusting pop-up messages in a browser;

an operation history that allows a timely receipt of the information regarding the operations performed at the self-service complex indicating the following information: a complex identifier, an operation type, an operation status, an operation time, an operation amount, a completion status (cancel, error, successful completion), a receipt number, an authorization code (if any). In case of the currency exchange operations, the following information must be stated in details: a currency to be exchanged from, a currency to be exchanged to, an exchange rate of the performed operation, a cash amount received, an amount of the target currency to be issued;

reporting that lies in creating reports on the operations performed. Displaying the report data must enable to perform exporting (saving as a file) and sorting by the report fields.

In order to provide a hardware (“physical”) safety of the system, according to the invention, the self-servicing SHC 2 implements a standard (in terms of financial services complexes) protocol for protecting against “physical” attacks: a metal housing that is rigidly secured to a floor, safes which are provided individually for each cash handling device (being the cash receiver and dispenser), an alarm, and complex unauthorized access sensors. The SHC 2 comprises three magnet locks with three magnet keys (being unique for each of the SHCs) corresponding thereto: “Doors opened”(external)—it disables the alarm when the SHC's housing is opened, “Collection”—it disables the alarm when the SHC's safes are opened, and it switches the control module to the “collection” mode, “Servicing”—it switches the control module to the “servicing” mode. Also, the video recording is provided, thereby the client's interaction with the complex is registered by two video cameras: a first camera is fixed on the client's identity, a second camera is fixed on a cash deposition operation area. The recorded video material is accessible remotely via the server.

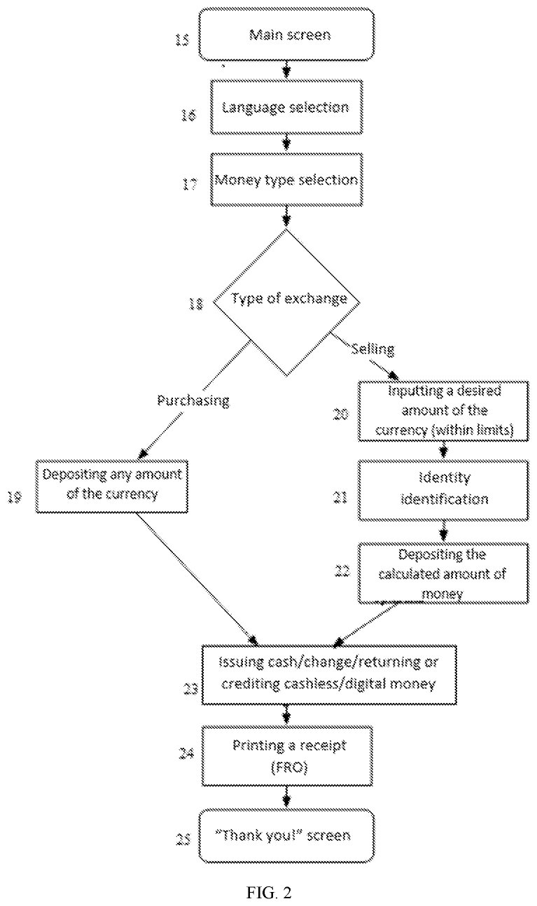

FIG. 2 illustrates the common implementation algorithm of the method for performing the currency exchange operation, according to which, after the client touches any part of a main screen 15 of the peripheral device (of the SHC or ATM) which displays money types being available for the exchange, currencies and exchange rates thereof, the process of performing the currency exchange operation will be initiated which starts from selection of a language 16 of the client interface of all next steps. The next step includes selecting a money type 17, wherein, according to the invention, it is possible to make the selection from three money types (cash/cashless/digital), selecting up to 26 currency types, and exchanging up to 6 currencies simultaneously, as well as selecting an exchange type 18 that implies the currency purchase or sale (from the client's point of view). For example, upon selection of the purchase as the exchange type, the client deposits any amount of the selected currency 19 in cash into the cash receiver, then the screen 15 displays a resulting amount in the local currency to be issued, wherein, at the present step, both the function of receiving the calculated amount in the local currency by the client and the function of canceling the exchange operation and returning the cash introduced into the cash receiver.

Therewith, the following cases may occur:

the resulting amount comprises a fraction in coins, then the main screen 15 displays a message saying that the peripheral device does not issue coins and indicating the money amount that is available for issuance without coins;

there are no small denomination cash of the local currency being sufficient to issue the exact resulting amount, then the main screen 15 displays a notification saying that there are no small denomination cash sufficient and indicating the amount that is available for issuance;

there are no cash of the local currency being sufficient to issue the amount that exceeds a defined currency equivalent, and when the deposited amount approaches to a threshold of the available amount, the main screen 15 will display a notification saying that a maximum possible exchange amount is achieved, while when an exceeding amount is deposited, the main screen 15 will display a message saying that the maximum possible exchange amount is exceeded and the cash receipt function will become unavailable, while only a function of returning to the next operation will remain available.

If the exchange type 18 in the form of the sale is selected, a desired currency amount (within the limit) 20 is input by means of the digital keyboard on the main screen 15 which will display the calculated purchase price in the local currency that should be paid to the client and the limit for the input amount, namely, a multiplicity that depends on the available currency denominations and the available limit in the form of the maximum amount for sale for a single transaction that is established by a financial regulator or by the SHC or ATM owner. If any one of the limitations is violated, the corresponding error text will appear beneath the input element, while if the input is correct, the currency purchase will occur accompanied by the step of depositing the calculated money amount depending on the type 22 thereof.

If the financial regulator requires to identify the currency purchaser starting from a defined amount or always or, e.g., if the established currency amount threshold is exceeded, an identity identification step 21 will be activated that lies in scanning a passport, making a photo of a face, and waiting for the identity confirmation. Therefore, the identity identification step 21 is optional and is activated in the above-listed cases.

A step of depositing the calculated amount of the local currency 22, according to the described embodiment of the invention, implies depositing the cash into the cash receiver, while if the amount of the deposited cash exceeds the calculated one, the cash receiver will be deactivated, a value of the change will be calculated, and a step of issuing the exchanged currency/local currency/change/returning 23 will be performed. Therewith, if there are no local currency cash sufficient for the issuance of the exact amount of the change, the main screen 1 will display a message text saying that there are no sufficient cash and indicating an available amount of the change, and then the client will be suggested either to receive the proposed available amount of the change or to cancel the operation and to return the deposited cash amount. According to the group of inventions, this step also implements a possibility of exchanging the cryptocurrencies BTC, BTH, LTC, DASH, ETH, RIPPLE which are known nowadays, although the exchange of any other cryptocurrencies is possible as well without falling beyond the concepts of the present group of inventions. The following operations may be performed: purchasing the cryptocurrencies by the cash payment (receiving the cash through the cash receiver), purchasing the cryptocurrencies by the cashless settlement by crediting the money from payment cards of the international payment system Visa International or MasterCard Worldwide, converting one type of the cryptocurrencies into another one, selling the cryptocurrencies.

The cash is issued by the dispenser, while during the return of the cash deposited by the client the SHC or the ATM takes the deposited cash in the same form as deposited by the client by means of the cash receiver mechanism Escrow that is implemented due to the presence of an additional cash storage compartment in the cash receiver (after the verification of the cash by means of a complex infrared and/or ultraviolet and/or magnetic and/or OCR scanning by the corresponding means integrated into the cash money receipt and issuance module of the peripheral device) and a mechanism for taking them back from this compartment.

When the currency exchange operation is completed, a step for printing a receipt 24 occurs by means of a receipt printer that may be equipped with an embedded FRO (Fiscal Registrar Operation) module, while an electronic receipt will be sent to a server of the Fiscal Service, and the main screen 15 displays an information regarding the successfully performed operation 25.

Considering the high transactionality of the self-service complex described according to the invention, the exchange actions implemented by means of the same also imply performing money transfers that implies an interaction between the complex and the following money transfer systems: MoneyGram, WesternUnion, RIA, UniStreamPlus, MasterCard, WellSend, but without limitation thereto.

The above-described embodiments of the group of invention should be used as an illustration only and should not limit their scope of claims. Obvious modifications of embodiments of the group of inventions may be easily made by persons skilled in this field of art without going beyond the essence thereof.

1. A method for performing a currency exchange operation, comprising:
a step of requesting an initiation of the currency exchange operation using a client interface of a peripheral device having an integrated extension for financial services (XFS) module that comprises selecting a currency type to be exchanged from, selecting a currency type to be exchanged to, selecting a money type from a range that includes cash, cashless or digital money, selecting a direction of the currency exchange operation from a range that includes purchasing, selling, converting, and entering a value of an initial amount of the operation with the selected currency and money types;
a step of confirming that the currency exchange operation is possible by transmitting the initiation request from the XFS module to a server device having an architecture that includes an external operator interface and a software and hardware part that is integrated according to an ISO protocol with a processing center for payment cards operations and with application programming interfaces (APIs) of payment services providers and automated systems of servicing banks, displaying the received data on the peripheral device interface with indication of an exchange rate of the set pair of currency types, limitation amounts of the exchange, and an amount of the currency type to be exchanged to depending on the amount of the currency type to be exchanged from;
a step of providing the currency to be exchanged from depending on the selected money type by depositing cash into a receipt device of a cash receipt and issuance module,
and/or a contact or contactless inputting of an information from a cashless money carrier into a cashless operations module that is equipped with a PIN-on-Glass technology and devices with near field communication (NFC),
and/or indicating a digital money identification data in a scanner code reader of the cashless operations module;
a step of verifying depending on the selected money type, which includes checking the cash money after its introduction into a receiving portion of the peripheral device, by means of a complex infrared and/or ultraviolet and/or magnetic and/or optical character recognition (OCR) scanning performed by appropriate means integrated into the cash money receipt and issuance module of the peripheral device,
and/or verifying payment cards upon request to hosts of a card processing systems provider and a respective servicing bank by means of an online transaction to a processing center of a local or international payment system in real time, while forming, by the processing center, a request to the system of the servicing bank and forming a response to the control module of the peripheral device,
and/or verifying a digital money account upon request to hosts of cryptocurrency providers by means of online verification according to a block chain technology;
wherein an intermediate step of additional initiation of selecting the currency type to be exchanged to from at least two money types is possible; and
a step of exchanging by means of issuing a calculated amount of cash money of the selected currency from the peripheral device, a cash dispenser or recycling module and/or debiting from a cashless account and/or crediting to the cashless account and/or debiting from a cryptocurrency account and/or crediting to the cryptocurrency account.

2. A system for implementing a method for performing a currency exchange operation, the system comprising: at least one self-service complex comprising a software and hardware complex, which includes an operational control device that is a computer having an operating system that supports financial services, the computer is embedded into the self-service complex, equipped with an external client interface, and integrated with a XFS financial services extension module, which is capable of controlling devices of the self-service complex modules, which are a cash money storage module, a cash money receipt and issuance module, a cashless payment operations module, and a security module, wherein the operational control device of the self-service complex is coupled to a processing center for payment cards operations, payment services providers, cryptocurrencies providers, and automated systems of servicing banks, by means of a direct interaction with a remote central server that is equipped with an operator interface and is coupled by ISO protocols to the processing center for payment cards operations, to APIs of the payment services providers and of the cryptocurrency providers, and to APIs and/or by means of a file exchange with the automated systems of the servicing banks;
wherein the operational control device of the complex is configured to initiate at least one currency exchange operation upon request through an external multilingual client interface with a formation of an authorization request to a central server, while the server provides in response, by calculating an exchange rate of at least one currency pair for at least one money type, limits of the amounts of currency exchange operation, and confirms that the currency exchange operation is possible by exchanging data with at least one processing center and the operational control device of the complex,
and, upon confirmation of the necessity of conduction, performing the currency exchange operation by means of a cash settlement through the money receipt and issuance module of the self-service complex, the module combines paper and/or coin cash money receipt/issuance devices and physical complex verification devices that are infrared and/or ultraviolet and/or magnetic and/or OCR scanners,
and/or debiting from a cashless account and/or crediting to the cashless account, upon request to hosts of cryptocurrency providers, through the module of cashless payment systems that implements ISO that combines a card reader, an EPP keyboard, and an NFC module, and/or debiting a digital money from a cryptocurrency account and/or crediting the digital money to the cryptocurrency account by online verification according to a block chain technology,
followed by formation and visualization of a report on a finalization of the currency exchange operation.

3. The system according to claim 2, characterized in that the currency exchange operation with the cash involves issuing a change and/or refunding the amount due to a presence of a means for temporary storing the cash after the complex verification thereof is performed.
